(19) United States
(12) Patent Application Publication
(10) Pub. No.: US 2018/0052360 A1
(43) Pub. Date: Feb. 22, 2018

(54) LIQUID CRYSTAL DISPLAY PANEL

(71) Applicants: SHENZHEN CHINA STAR OPTOELECTRONICS TECHNOLOGY CO., LTD., GUANGDONG (CN); WUHAN CHINA STAR OPTOELECTRONICS TECHNOLOGY CO., LTD., HUBEI (CN)

(72) Inventors: Hongqing CUI, GUANGDONG (CN); Xinhui ZHONG, GUANGDONG (CN)

(21) Appl. No.: 15/116,217

(22) PCT Filed: Apr. 8, 2016
(86) PCT No.: PCT/CN2016/078767

§ 371 Date: Aug. 3, 2016

(30) Foreign Application Priority Data
Mar. 17, 2016 (CN) 201610154473.6

(51) Int. Cl. G02F 1/1335; G02F 1/1343; G02F 1/1337

(52) U.S. Cl. CPC G02F 1/133528; G02F 1/1343; G02F 1/133512; G02F 1/1337; G02F 1/133514

(57) ABSTRACT

A liquid crystal display panel is provided. The liquid crystal display panel has a transmission display area and a reflection display area. The transmission display area has an upper substrate, an upper polarizer, a color filter, a lower substrate, a lower polarizer, a first pixel electrode and a liquid crystal layer; and the reflection display area has the upper substrate, a half wave plate, the upper polarizer, the color filter, a common electrode, the lower substrate, a second pixel electrode and the liquid crystal layer.

### FIELD OF THE INVENTION

The present invention relates to a liquid crystal display field, and more particularly to a liquid crystal display panel.

### BACKGROUND OF THE INVENTION

With the gradual development of products and applications of wearable devices, such as intelligent watches, intelligent glasses, etc., given a fixed quantity of electricity of a battery, the endurance ability of the whole of the product will be greatly influenced by an energy consumption issue, so that the development of a low-consumption/high-performance display is important.

According to an analysis of the purpose and the habits of people using liquid crystal display panels, a high performance display is necessary (high resolution, high contrast, high color gamut, etc.), but as an alternative, a low-consumption/low-performance display, may be selected in some application situations.

In other words, when watching a video or image, the high-performance liquid crystal display panel is used to provide the user a bright visual enjoyment; but when the quantity of electricity of the battery is low, or only text information needs to be viewed, a power saving mode of the liquid crystal display panel can be used, so that the liquid crystal display panel under the mode just can display the necessary contents, so as to lengthen the endurance time of the battery. However, the manufacturing cost of the above-mentioned liquid crystal display panel is higher, and the energy saving effect thereof under the power saving mode is not good enough.

Hence, it is necessary to provide a liquid crystal display panel which solves the problems existing in the traditional technology.

### SUMMARY OF THE INVENTION

In view of this, the present invention provides a liquid crystal display panel which has a high reflect ratio and a better display effect for displaying images, so as to solve the technical problem: a traditional liquid crystal display panel easily has a low reflect ratio and is poor in color mixture.

The present invention provides a liquid crystal display panel, comprising a transmission display area and a reflection display area, wherein the transmission display area includes:

an upper substrate;
an upper polarizer disposed on an outer surface of the upper substrate and configured to filter a first emergent light with a default polarization condition;
a color filter disposed on an inner surface of the upper substrate and configured to filter the first emergent light with a default color wavelength;
a lower substrate;
a lower polarizer disposed on an outer surface of the lower substrate and configured to filter a first incident light with a default polarization condition;
a first pixel electrode disposed on an inner surface of the lower substrate and configured to provide a first driving voltage and a common voltage; and
a liquid crystal layer disposed between the color filter and the first pixel electrode, and configured to deflect the first incident light to form the first emergent light;
wherein the reflection display area includes:
the upper substrate;
a half wave plate disposed on an outer surface of the upper substrate and configured to change a polarization condition of a second emergent light;
the upper polarizer further disposed on an outer surface of the half wave plate and configured to filter the second emergent light with a default polarization condition;
the color filter;
a common electrode disposed on an inner surface of the color filter and configured to provide a common voltage;
the lower substrate;
a second pixel electrode disposed on an inner surface of the lower substrate and configured to provide a second driving voltage and configured to reflect an exterior ambient light; and
the liquid crystal layer further disposed between the color filter and the second pixel electrode, and configured to deflect the second incident light to form the second emergent light;
wherein the display mode of the transmission display area of the liquid crystal display panel is an IPS display mode or an FFS display mode; and the display mode of the reflection display area of the liquid crystal display panel is an ECB display mode; and
wherein the thickness of the liquid crystal layer in the transmission display area is greater than that of the liquid crystal layer in the reflection display area.

In the liquid crystal display panel according to the present invention, the display mode of the transmission display area of the liquid crystal display panel is the FFS display mode; the first pixel electrode includes first sub pixel electrodes configured for providing a first driving voltage and second sub pixel electrodes configured for providing a common voltage, and the first sub pixel electrodes and the second sub pixel electrodes are alternately arranged with each other.

In the liquid crystal display panel according to the present invention, the display mode of the transmission display area of the liquid crystal display panel is the IPS display mode; the first pixel electrode includes first sub pixel electrodes configured for providing a first driving voltage and a second sub pixel electrode configured for providing a common voltage; and the first sub pixel electrodes are separately disposed in a first electrode layer of the first pixel electrode, and the second sub pixel electrode is disposed in a second electrode layer of the first pixel electrode, wherein the first electrode layer is separated from the second electrode layer by an insulation layer.

In the liquid crystal display panel according to the present invention, the transmission display area further includes a first flat layer disposed between the color filter and the liquid crystal layer; and

the reflection display area further includes a second flat layer disposed between the color filter and the common electrode.

In the liquid crystal display panel according to the present invention, the transmission display area further includes a first alignment layers disposed between the first flat layer and the liquid crystal layer, and between the liquid crystal layer and the first pixel electrode; and

the reflection display area further includes a second alignment layers disposed between the second flat layer and the liquid crystal layer, and between the liquid crystal layer and the second pixel electrode.

In the liquid crystal display panel according to the present invention, an included angle between a fast axis direction of the half wave plate and a transmission axis direction of the upper polarizer is 22.5 degrees.

In the liquid crystal display panel according to the present invention, the transmission display area further includes a black matrix.

In the liquid crystal display panel according to the present invention, the transmission display area further includes a first light source configured to provide the first incident light; and

the reflection display area further includes a second light source configured to provide the second incident light.

In the liquid crystal display panel according to the present invention, the liquid crystal display panel comprises one transmission display area and one reflection display area, wherein the reflection display area is disposed on a top side of the transmission display area.

The present invention provides a liquid crystal display panel, comprising a transmission display area and a reflection display area, wherein the transmission display area includes:

an upper substrate;
an upper polarizer disposed on an outer surface of the upper substrate and configured to filter a first emergent light with a default polarization condition;
a color filter disposed on an inner surface of the upper substrate and configured to filter the first emergent light with a default color wavelength;
a lower substrate:
a lower polarizer disposed on an outer surface of the lower substrate and configured to filter a first incident light with a default polarization condition;
a first pixel electrode disposed on an inner surface of the lower substrate and configured to provide a first driving voltage and a common voltage; and
a liquid crystal layer disposed between the color filter and the first pixel electrode, and configured to deflect the first incident light to form the first emergent light;
wherein the reflection display area includes:
the upper substrate;
a half wave plate disposed on an outer surface of the upper substrate and configured to change a polarization condition of a second emergent light;
the upper polarizer further disposed on an outer surface of the half wave plate and configured to filter the second emergent light with a default polarization condition;
the color filter;
a common electrode disposed on an inner surface of the color filter and configured to provide a common voltage;
the lower substrate;
a second pixel electrode disposed on an inner surface of the lower substrate and configured to provide a second driving voltage and configured to reflect an exterior ambient light; and
the liquid crystal layer further disposed between the color filter and the second pixel electrode, and configured to deflect the second incident light to form the second emergent light.

In the liquid crystal display panel according to the present invention, the display mode of the transmission display area of the liquid crystal display panel is an IPS display mode or an FFS display mode; and the display mode of the reflection display area of the liquid crystal display panel is an ECB display mode.

In the liquid crystal display panel according to the present invention, the display mode of the transmission display area of the liquid crystal display panel is the FFS display mode; the first pixel electrode includes first sub pixel electrodes configured for providing a first driving voltage and second sub pixel electrodes configured for providing a common voltage, and the first sub pixel electrodes and the second sub pixel electrodes are alternately arranged with each other.

In the liquid crystal display panel according to the present invention, the display mode of the transmission display area of the liquid crystal display panel is the IPS display mode; the first pixel electrode includes first sub pixel electrodes configured for providing a first driving voltage and a second sub pixel electrode configured for providing a common voltage; and the first sub pixel electrodes are separately disposed in a first electrode layer of the first pixel electrode, and the second sub pixel electrode is disposed in a second electrode layer of the first pixel electrode, wherein the first electrode layer is separated from the second electrode layer by an insulation layer.

In the liquid crystal display panel according to the present invention, the transmission display area further includes a first flat layer disposed between the color filter and the liquid crystal layer; and

the reflection display area further includes a second flat layer disposed between the color filter and the common electrode.

In the liquid crystal display panel according to the present invention, the transmission display area further includes a first alignment layers disposed between the first flat layer and the liquid crystal layer, and between the liquid crystal layer and the first pixel electrode; and

the reflection display area further includes a second alignment layers disposed between the second flat layer and the liquid crystal layer, and between the liquid crystal layer and the second pixel electrode.

In the liquid crystal display panel according to the present invention, the thickness of the liquid crystal layer in the transmission display area is greater than that of the liquid crystal layer in the reflection display area.

In the liquid crystal display panel according to the present invention. an included angle between a fast axis direction of the half wave plate and a transmission axis direction of the upper polarizer is 22.5 degrees.

In the liquid crystal display panel according to the present invention, the transmission display area further includes a black matrix.

In the liquid crystal display panel according to the present invention, the transmission display area further includes a first light source configured to provide the first incident light; and

the reflection display area further includes a second light source configured to provide the second incident light.

In the liquid crystal display panel according to the present invention, the liquid crystal display panel comprises one transmission display area and one reflection display area, wherein the reflection display area is disposed on a top side of the transmission display area.

By disposing the transmission display area and the reflection display area, the liquid crystal display panel according to the present invention can sufficiently use an ambient light in a power saving situation, so that it has a high reflect ratio and a better color image display effect, so as to solve the technical problem: a traditional liquid crystal display panel easily has a low reflect ratio and is poor in color mixture.

### DESCRIPTION OF THE DRAWINGS

In order to more clearly illustrate the utility model embodiments or the prior art technical solutions, the embodiment is simply described with needed accompanying drawings. The following description the drawings are merely the utility model to some embodiments, those of ordinary skill in the art, without creative efforts, can derive other drawings from these drawings.

FIG. 1 is a schematic structural view of a liquid crystal display panel according to a preferred embodiment of the present invention;

FIG. 2 is an partial enlarged view of an A-part in FIG. 1;

FIG. 3 is a cross section view of a cross section line B-B′ of FIG. 2;

FIG. 4 is one schematic structural view of a first pixel electrode of a liquid crystal display panel according to the present invention; and

FIG. 5 is another one schematic structural view of a first pixel electrode of a liquid crystal display panel according to the present invention.

### DETAILED DESCRIPTION OF THE PREFERRED EMBODIMENTS

Referring to the drawings, wherein the same reference numbers stand for same assemblies. The descriptions below are based on specific embodiments of the illustrated present disclosure, and the specific embodiments should not be considered as a limitation to other specific embodiments not described herein.

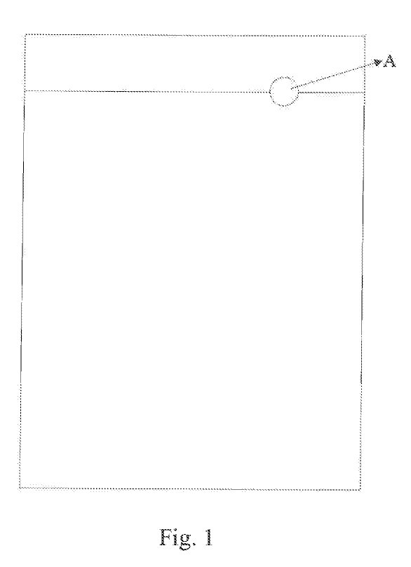

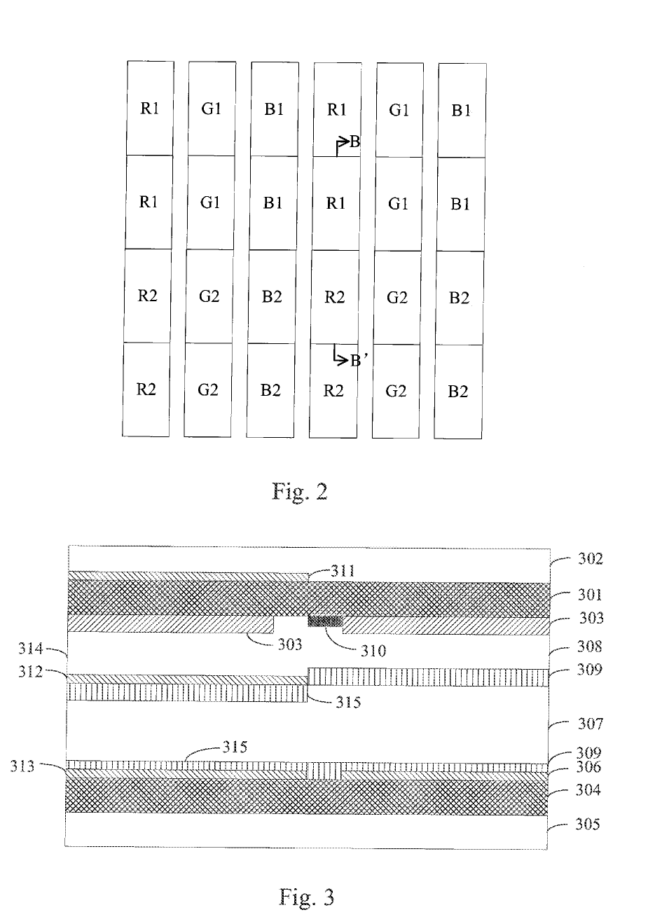

Refer now to FIG. 1 to FIG. 3, wherein FIG. 1 is a schematic structural view of a liquid crystal display panel according to a preferred embodiment of the present invention; FIG. 2 is an partial enlarged view of an A-part in FIG. 1; and FIG. 3 is a cross section view of a cross section line B-B′ of FIG. 2.

As shown in FIGS. 1 and 2, the liquid crystal display panel according to the preferred embodiment comprises a transmission display area and a reflection display area, wherein the transmission display area displays an image by a light transmission of a backlight light source, and the reflection display area displays an image by a reflection of an exterior ambient light or a light transmission of a backlight light source. In the preferred embodiment, the liquid crystal display panel comprises one transmission display area and one reflection display area, wherein the reflection display area is disposed on a top side of the transmission display area. In FIG. 2, R1 is a red pixel of the reflection display area, B1 is a blue pixel of the reflection display area, and G1 is a green pixel of the reflection display area; and R2 is a red pixel of the transmission display area, B2 is a blue pixel of the transmission display area, and G2 is a green pixel of the transmission display area.

Refer now to FIG. 3, the transmission display area of the liquid crystal display panel includes an upper substrate 301, an upper polarizer 302, a color filter 303, a lower substrate 304, a lower polarizer 305, a first pixel electrode 306, a liquid crystal layer 307, a first flat layer 308, two first alignment layers 309, a first light source (not shown in the figures), and a black matrix 310.

The upper polarizer 302 is disposed on an outer surface of the upper substrate 301, and is used to filter a first emergent light with a default polarization condition. The color filter 303 is disposed on an inner surface of the upper substrate 301, and is used to filter the first emergent light with a default color wavelength. The lower polarizer 305 is disposed on an outer surface of the lower substrate 304, and is used to filter a first incident light with a default polarization condition. The first pixel electrode 306 is disposed on an inner surface of the lower substrate 304, and is used to provide a first driving voltage and a common voltage. The liquid crystal layer 307 is disposed between the color filter 303 and the first pixel electrode 306, and is used to deflect the first incident light to form the first emergent light.

The first flat layer 308 is disposed between the color filter 303 and the liquid crystal layer 307, and is used to process a planarization to an inner surface of the color filter 303. The first alignment layers 309 are disposed between the first flat layer 308 and the liquid crystal layer 307, and between the liquid crystal layer 307 and the first pixel electrode 306, and are used to process an alignment to liquid crystal molecules of the liquid crystal layer 307 in the transmission display area. The first light source is used to provide the incident light. The black matrix 310 is used to separate the color filters with different colors.

The reflection display area of the liquid crystal display panel includes an upper substrate 301, a half wave plate 311, an upper polarizer 302, a color filter 303, a common electrode 312, a lower substrate 304, a lower polarizer 305, a second pixel electrode 313, a liquid crystal layer 307, a second flat layer 314, and two second alignment layers 315.

The half wave plate 311 is disposed on an outer surface of the upper substrate 301, and is used to change a polarization condition of a second emergent light. The upper polarizer 302 is further disposed on an outer surface of the half wave plate 311, and is used to filter the first emergent light with a default polarization condition. The common electrode 312 is disposed on an inner surface of the color filter 303, and is used to provide a common voltage. The second pixel electrode 313 is disposed on an inner surface of the lower substrate 304, and is used to provide a second driving voltage and used to reflect an exterior ambient light. The liquid crystal layer 307 is further disposed between the color filter 303 and the second pixel electrode 313, and is used to deflect the second incident light to form the second emergent light.

The second flat layer 314 is disposed between the color filter 303 and the common electrode 312, and is used to process a planarization to an inner surface of the color filter 303. The second alignment layers 315 are disposed between the second flat layer 314 and the liquid crystal layer 307, and between the liquid crystal layer 307 and the second pixel electrode 313, and are used to process an alignment to liquid crystal molecules of the liquid crystal layer 307 in the reflection display area.

The thickness of the liquid crystal layer 307 in the transmission display area is greater than that of the liquid crystal layer 307 in the reflection display area, for example, the thickness of the liquid crystal layer 307 in the transmission display area is twice the thickness of the liquid crystal layer 307 in the reflection display area, so that the display difference between the transmission display area and the reflection display area can be less. An included angle between a fast axis direction of the half wave plate 311 and a transmission axis direction of the upper polarizer 302 is 22.5 degrees.

The display mode of the transmission display area of the liquid crystal display panel according to the preferred embodiment is an FFS (Fringe Field Switching) display mode or an IPS (In-Plane Switching) display mode. The display mode of the reflection display area of the liquid crystal display panel according to the preferred embodiment is an ECB (electrically controlled birefringence) display mode.

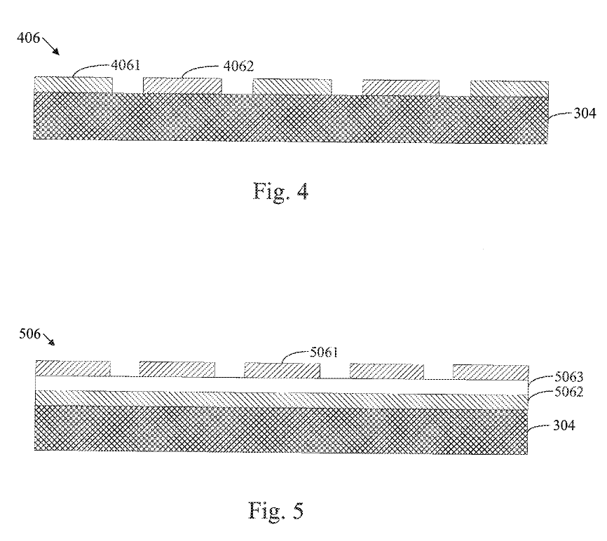

If the display mode of the transmission display area of the liquid crystal display panel is the EFS display mode, a structure of a first pixel electrode 406 is shown in FIG. 4, wherein the first pixel electrode 406 includes first sub pixel electrodes 4061 used for providing a first driving voltage and second sub pixel electrodes 4062 used for providing a common voltage, and the first sub pixel electrodes 4061 and the second sub pixel electrodes 4062 are alternately arranged with each other.

If the display mode of the transmission display area of the liquid crystal display panel is the IPS display mode, a structure of a first pixel electrode 506 is shown in FIG. 5, wherein the first pixel electrode 506 includes first sub pixel electrodes 5061 used for providing a first driving voltage and a second sub pixel electrode 5062 used for providing a common voltage. The first sub pixel electrodes 5061 are separately disposed in a first electrode layer of the first pixel electrode 506, and the second sub pixel electrode 5062 is disposed in a second electrode layer of the first pixel electrode 506, wherein the first electrode layer is separated from the second electrode layer by an insulation layer 5063.

When the liquid crystal display panel according to the preferred embodiment is used, if the liquid crystal display panel is under a high-performance display mode, the transmission display area of the liquid crystal display panel is active, and the first pixel electrode 306 is inputted a first driving voltage and a common voltage. That is, the first light source provides a first incident light, and the first incident light is transformed into a first incident light with a default polarization condition through the lower polarizer 305. The first incident light with the default polarization condition is deflected through the liquid crystal layer 307, and then transformed into a first emergent light with a default color wavelength through the color filter 303, and finally the first emergent light with the default polarization condition is outputted through the upper polarizer 302, so as to carry out a display of color image. The transmission display area of the liquid crystal display panel is in a bright situation.

The reflection display area of the liquid crystal display panel is inactive, and the second pixel electrode 313 and the common electrode 312 are not inputted signals. An exterior ambient light of the reflection display area of the liquid crystal display panel is transformed into an exterior ambient light with a default polarization condition through the upper polarizer 302, such as a line polarization light of 90 degrees. The exterior ambient light with the default polarization condition then passes through the half wave plate 311 (the fast axis direction of the half wave plate 311 is 67.5 degrees), and the polarization direction thereof is rotated 45 degrees, such as a line polarization light of 45 degrees. Next, the exterior ambient light passes through the liquid crystal layer 307, and is reflected by the second pixel electrode 313 to be transformed into a second incident light. The second incident light passes through the liquid crystal layer 307 again to be transformed into a second emergent light, and the polarization degree of the second emergent light is 135 degrees. The second emergent light passes through the color filter 303 to be transformed into the second emergent light with a default color wavelength, and finally the second emergent light with the default color wavelength is outputted through the half wave plate 311 to be transformed into the second emergent light of 0 degrees, and is stopped by the upper polarizer 302. The reflection display area of the liquid crystal display panel is in a dark situation, namely the reflection display area of the liquid crystal display panel is under a normal black display mode.

When the liquid crystal display panel is under a power saving display mode, the reflection display area of the liquid crystal display panel is active. That is:

the second pixel electrode 313 is inputted a second voltage, and the common electrode 312 is inputted a common voltage. An exterior ambient light of the reflection display area of the liquid crystal display panel is transformed into an exterior ambient light with a default polarization condition through the upper polarizer 302, such as a line polarization light of 90 degrees. The exterior ambient light with a default polarization condition then passes through the half wave plate 311 (the fast axis direction of the half wave plate 311 is 67.5 degrees), and the polarization direction thereof is rotated 45 degrees, such as a line polarization light of 45 degrees. Next, the exterior ambient light passes through the liquid crystal layer 307 (at this moment, the liquid crystal molecules are vertically arranged, and without anisotropic), and is reflected by the second pixel electrode 313 to be transformed into a second incident light. The second incident light passes through the liquid crystal layer 307 again to be transformed into a second emergent light. The second emergent light passes through the color filter 303 to be transformed into the second emergent light with a default color wavelength, and finally the second emergent light with the default color wavelength is outputted through the half wave plate 311 to be transformed into the second emergent light of 90 degree, and can be outputted through the upper polarizer 302, so as to carry out a display of color image. The reflection display area of the liquid crystal display panel is brightened.

The transmission display area of the liquid crystal display panel is inactive, and the first pixel electrode 306 is not inputted a signal. At this moment, the first light source does not emit the first incident light, so that the transmission display area of the liquid crystal display panel is darkened, namely the transmission display area of the liquid crystal display panel is under a normal black display mode.

Preferably, the liquid crystal display panel further comprises a second light source (not shown in figures) used to provide a second incident light. When the liquid crystal display panel is under power saving mode, if the brightness of the exterior ambient light is lower, the second incident light can be used to directly provide the second incident light to the reflection display area.

The present invention has been described with preferred embodiments thereof and it is understood that many changes and modifications to the described embodiments can be carried out without departing from the scope and the spirit of the invention that is intended to be limited only by the appended claims.

What is claimed is:

1. A liquid crystal display panel, comprising a transmission display area and a reflection display area,
wherein the transmission display area includes:
an upper substrate;
an upper polarizer disposed on an outer surface of the upper substrate and configured to filter a first emergent light with a default polarization condition;
a color filter disposed on an inner surface of the upper substrate and configured to filter the first emergent light with a default color wavelength;
a lower substrate;
a lower polarizer disposed on an outer surface of the lower substrate and configured to filter a first incident light with a default polarization condition;
a first pixel electrode disposed on an inner surface of the lower substrate and configured to provide a first driving voltage and a common voltage; and
a liquid crystal layer disposed between the color filter and the first pixel electrode, and configured to deflect the first incident light to form the first emergent light;
wherein the reflection display area includes:
the upper substrate;
a half wave plate disposed on an outer surface of the upper substrate and configured to change a polarization condition of a second emergent light;
the upper polarizer further disposed on an outer surface of the half wave plate and configured to filter the second emergent light with a default polarization condition;
the color filter;
a common electrode disposed on an inner surface of the color filter and configured to provide a common voltage;
the lower substrate;
a second pixel electrode disposed on an inner surface of the lower substrate and configured to provide a second driving voltage and configured to reflect an exterior ambient light; and
the liquid crystal layer further disposed between the color filter and the second pixel electrode, and configured to deflect the second incident light to form the second emergent light;
wherein the display mode of the transmission display area of the liquid crystal display panel is an IPS display mode or an FFS display mode; and the display mode of the reflection display area of the liquid crystal display panel is an ECB display mode; and
wherein the thickness of the liquid crystal layer in the transmission display area is greater than that of the liquid crystal layer in the reflection display area.

2. The liquid crystal display panel according to claim 1, wherein the display mode of the transmission display area of the liquid crystal display panel is the FFS display mode; the first pixel electrode includes first sub pixel electrodes configured to provide a first driving voltage and second sub pixel electrodes configured to provide a common voltage, and the first sub pixel electrodes and the second sub pixel electrodes are alternately arranged with each other.

3. The liquid crystal display panel according to claim 1, wherein the display mode of the transmission display area of the liquid crystal display panel is the IPS display mode; the first pixel electrode includes first sub pixel electrodes configured to provide a first driving voltage and a second sub pixel electrode configured to provide a common voltage; and the first sub pixel electrodes are separately disposed in a first electrode layer of the first pixel electrode, and the second sub pixel electrode is disposed in a second electrode layer of the first pixel electrode, wherein the first electrode layer is separated from the second electrode layer by an insulation layer.

4. The liquid crystal display panel according to claim 1, wherein the transmission display area further includes a first flat layer disposed between the color filter and the liquid crystal layer; and
the reflection display area further includes a second flat layer disposed between the color filter and the common electrode.

5. The liquid crystal display panel according to claim 4, wherein the transmission display area further includes a first alignment layers disposed between the first flat layer and the liquid crystal layer, and between the liquid crystal layer and the first pixel electrode; and
the reflection display area further includes a second alignment layers disposed between the second flat layer and the liquid crystal layer, and between the liquid crystal layer and the second pixel electrode.

6. The liquid crystal display panel according to claim 1, wherein an included angle between a fast axis direction of the half wave plate and a transmission axis direction of the upper polarizer is 22.5 degrees.

7. The liquid crystal display panel according to claim 1, wherein the transmission display area further includes a black matrix.

8. The liquid crystal display panel according to claim 1, wherein the transmission display area further includes a first light source configured to provide the first incident light; and
the reflection display area further includes a second light source configured to provide the second incident light.

9. The liquid crystal display panel according to claim 1, wherein the liquid crystal display panel comprises one of the transmission display area and one of the reflection display area, wherein the reflection display area is disposed on a top side of the transmission display area.

10. A liquid crystal display panel, comprising a transmission display area and a reflection display area,
wherein the transmission display area includes:
an upper substrate;
an upper polarizer disposed on an outer surface of the upper substrate and configured to filter a first emergent light with a default polarization condition;
a color filter disposed on an inner surface of the upper substrate and configured to filter the first emergent light with a default color wavelength;
a lower substrate;
a lower polarizer disposed on an outer surface of the lower substrate and configured to filter a first incident light with a default polarization condition;
a first pixel electrode disposed on an inner surface of the lower substrate and configured to provide a first driving voltage and a common voltage; and
a liquid crystal layer disposed between the color filter and the first pixel electrode, and configured to deflect the first incident light to form the first emergent light;
wherein the reflection display area includes:
the upper substrate;
a half wave plate disposed on an outer surface of the upper substrate and configured to change a polarization condition of a second emergent light;
the upper polarizer further disposed on an outer surface of the half wave plate and configured to filter the second emergent light with a default polarization condition;
the color filter;
a common electrode disposed on an inner surface of the color filter and configured to provide a common voltage;
the lower substrate;
a second pixel electrode disposed on an inner surface of the lower substrate and configured to provide a second driving voltage and configured to reflect an exterior ambient light; and
the liquid crystal layer further disposed between the color filter and the second pixel electrode, and configured to deflect the second incident light to form the second emergent light.

11. The liquid crystal display panel according to claim 10, wherein the display mode of the transmission display area of the liquid crystal display panel is an IPS display mode or an FFS display mode; and the display mode of the reflection display area of the liquid crystal display panel is an ECB display mode.

12. The liquid crystal display panel according to claim 11, wherein the display mode of the transmission display area of the liquid crystal display panel is the FFS display mode; the first pixel electrode includes first sub pixel electrodes configured to provide a first driving voltage and second sub pixel electrodes configured to provide a common voltage, and the first sub pixel electrodes and the second sub pixel electrodes are alternately arranged with each other.

13. The liquid crystal display panel according to claim 11, wherein the display mode of the transmission display area of the liquid crystal display panel is the IPS display mode; the first pixel electrode includes first sub pixel electrodes configured to provide a first driving voltage and a second sub pixel electrode configured to provide a common voltage; and the first sub pixel electrodes are separately disposed in a first electrode layer of the first pixel electrode, and the second sub pixel electrode is disposed in a second electrode layer of the first pixel electrode, wherein the first electrode layer is separated from the second electrode layer by an insulation layer.

14. The liquid crystal display panel according to claim 11, wherein the transmission display area further includes a first flat layer disposed between the color filter and the liquid crystal layer; and
the reflection display area further includes a second flat layer disposed between the color filter and the common electrode.

15. The liquid crystal display panel according to claim 11, wherein the transmission display area further includes a first alignment layers disposed between the first flat layer and the liquid crystal layer, and between the liquid crystal layer and the first pixel electrode; and
the reflection display area further includes a second alignment layers disposed between the second flat layer and the liquid crystal layer, and between the liquid crystal layer and the second pixel electrode.

16. The liquid crystal display panel according to claim 11, wherein the thickness of the liquid crystal layer in the transmission display area is greater than that of the liquid crystal layer in the reflection display area.

17. The liquid crystal display panel according to claim 11, wherein an included angle between a fast axis direction of the half wave plate and a transmission axis direction of the upper polarizer is 22.5 degrees.

18. The liquid crystal display panel according to claim 11, wherein the transmission display area further includes a black matrix.

19. The liquid crystal display panel according to claim 11, wherein the transmission display area further includes a first light source configured to provide the first incident light; and
the reflection display area further includes a second light source configured to provide the second incident light.

20. The liquid crystal display panel according to claim 11, wherein the liquid crystal display panel comprises one of the transmission display area and one of the reflection display area, wherein the reflection display area is disposed on a top side of the transmission display area.
